(19) United States
(12) Patent Application Publication
(10) Pub. No.: US 2007/0039781 A1
(43) Pub. Date: Feb. 22, 2007

(54) Belting ladder

(76) Inventor: James L. Ashmus, Kenosha, WI (US)

Correspondence Address: JANSSON, SHUPE, MUNGER & ANTARAMIAN, LTD, 245 MAIN STREET, RACINE, WI, 53403, US

(21) Appl. No.: 11/207,409

(22) Filed: Aug. 19, 2005

(51) Int. Cl. E06C 1/52

(52) U.S. Cl. 182/196

(57) ABSTRACT

A belting ladder including an elongated band of a flat flexible reinforced belting material having a plurality of longitudinally-spaced apertures each with a substantially transverse edge portion thereby forming rung-like features along the belting material to receive a person's foot or hand; and an attachment device at an end of the band. In certain desired embodiments, an attachment device secures the belting ladder to a storage arrangement for anchoring to a building. An endless belting ladder formed by an endless elongated band of a flat flexible reinforced belting material having a plurality of longitudinally-spaced apertures each with a substantially transverse edge portion thereby forming rung-like features along the belting material to receive a person's foot or hand.

### FIELD OF THE INVENTION

The present invention relates to flexible ladders for emergency escape from buildings, evacuation by air, drop from a helicopter or airplane, on the sides of boats or other settings where a collapsible ladder is required.

### BACKGROUND OF THE INVENTION

A variety of flexible ladders and the like have long existed for use in various emergency situations, a prime example of which is use for escape from burning buildings. Among other things, the prior art includes a variety of rope ladders, ladders with rigid rungs connected by ropes or chains, flat bands intended for use in descending, and other structures which can be collapsible for storage purposes.

Many of the prior art devices have significant disadvantages and shortcomings and there is a need for innovation in the field. For some devices, collapsing for compact storage is problematic or has disadvantages. There may be difficulty in unfurling the structure for use in a time of emergency, with susceptibility to problems such as tangling. Certain prior disclosures of flat band devices have problematic slit-like features which can tend to pose difficulties for persons trying to lower themselves—problems related to difficulty in securing proper foot engagement with the device. Excessive flexibility is another problem, as is limited capability for dealing concurrently with multiple persons seeking to escape, e.g., from a burning building. Furthermore, it is noted that potential revisions of prior structures for the purpose of alleviating certain problems can introduce or exacerbate other problems.

An important issue for any escape ladder is its immediate availability in fully operative condition in case of emergencies, which may happen decades after installation. Such availability can be achieved by storing escape ladders immediately next to windows or on the roof of a building in such a way that, when needed, the ladder can be dropped down for evacuation. Certain collapsible ladders may tend not to withstand long-term outdoor storage because of being susceptible to rot, rust and other types of destruction. Prior art ladders may need to either be covered by protective structure outside or stored inside which can also require additional camouflage for interior aesthetics.

In summary, there is a need for an improved collapsible ladder that overcomes some of the problems and shortcomings of the prior art, and provides highly reliable fire-escape apparatus.

### OBJECTS OF THE INVENTION

It is an object of the invention to provide an improved fire-escape device overcoming some of the problems and shortcomings of the prior art, including those referred to above.

Another object of the invention is to provide an improved ladder-like device which is sufficiently flexible to facilitate compact storage while being sufficiently fixed in its form to facilitate unfurling and stability of position during usage in an emergency.

Another object of the invention is to provide an improved fire-escape ladder-like device having the advantages mentioned herein and at the same time allowing relatively effortless positioning by a person of his or her feet and hands thereon for secure descend.

Still another object of the invention is to provide an improved ladder-like device which can be readily stored inside or outside for an extended period of time.

Yet another object of the invention is to provide an improved ladder-like device readily adapted for securement to the wall or a roof of a building.

Another object of the invention is to provide an improved ladder-like device adapted for easy portability by a person.

How these and other objects are accomplished will become apparent from the following descriptions and the drawings.

### SUMMARY OF THE INVENTION

The present invention provides an improved flexible ladder-like device in the form of a belting ladder designed for secure, relatively effortless descent of a person from a building or the like. The belting ladder may be designed to be secured to a building wall or roof for a long term storage and immediate access in case of emergency evacuation from the building. The invention may also be adapted to be easily portable by a single person, such as a firefighter, for brining the ladder to an area without any other escape-way.

The inventive belting ladder includes an elongated band of a flat flexible reinforced belting material having a plurality of longitudinally-spaced apertures each with a substantially transverse edge portion thereby forming rung-like features along the belting material to receive a person's foot or hand; and an attachment device at an end of the band.

The attachment device is for securing the ladder with respect to a wall or roof of a building—or any other suitable building element. The attachment device may be adapted for securing a portable belting ladder to a helicopter or plane, or simply a tree, to allow a person to descend (or ascend) as needed.

In the inventive belting ladder, the preferred belting material of the elongated band is conveyer belting—i.e., material of the type used for conveyor belts. The term “conveyer belting” as used herein refers to tough flat polymeric materials such as rubber, nylon, PVC or other strong yet flexible material which is flexible in the sense and to the extent that it can be rolled up into a coil but still retains sufficient form when a user's weight is applied at an aperture therein. Such conveyor belting typically includes flexible elongate reinforcement elements therein which extend through, are surrounded by, and adhere to the flat polymeric belting material. The elongate reinforcement may be made of metal, polymer, fiber, vegetable textile threads or other suitable materials used for manufacturing conveyer belting.

There is a wide variety of conveyor belting material which is suitable for the present invention and the above definition is in no way limiting for a special type of belting material. Moreover, new, used or scrap conveyer belting can also be used for the present invention.

In certain preferred embodiments the apertures have substantially round shapes with preferred diameter of approximately six inches.

In some preferred embodiments the transverse edge portions are substantially straight horizontal edges with the belting ladder being vertically oriented. In some of such embodiments, the apertures have substantially rectangular shapes preferably having width and height of approximately six inches.

In certain highly preferred embodiments the attachment device is adapted to secure the ladder with respect to a wall of a building. In such preferred embodiments the attachment device comprises a bracket pivotably connected to a hinge fastened to the end of the belting ladder.

In other certain highly preferred embodiments the belting ladder is designed for coiling into a roll dimensioned for carrying by a person as a backpack. In such embodiments, the attachment device is an arrangement comprising a hook linked with a chain coupled to the end of the belting ladder.

In another preferred embodiment of this invention the attachment device is a mechanism for mounting the belting ladder on a roof of a building.

In special highly preferred embodiments the inventive belting ladder constitutes a fire-escape belting ladder for a building. In such fire-escape, the attachment device secures the belting ladder to a storage arrangement for anchoring to the building. The belting ladder forms a coil for storing, and the attachment device includes a tug-tab for releasing the belting ladder from a coiled orientation into an extended suspended orientation. In some cases, the fire-escape belting ladder may further include an alarm-actuated device for releasing the belting ladder.

In the most preferred of these embodiments, the storage arrangement includes at least one substantially cylindrical member rotatably secured with respect to a support structure for anchoring to a building. The end of the belting ladder is secured to the cylindrical member.

Another aspect of this invention is an endless belting ladder comprising an endless elongated band of the same type as described above. Such endless belting ladder may form an escape system for a building by securing the endless band on a pulley system for the continuing descending movement of the belting ladder.

### BRIEF DESCRIPTION OF THE DRAWINGS

FIG. 1 is a front view of a belting ladder in accordance with this invention.

FIG. 2 is a front elevation of the belting ladder featuring an attachment device adapted for the ladder designed to be carried by a person as a backpack, and showing apertures having substantially round shapes.

FIG. 3 is a front elevation of the belting ladder featuring an attachment device adapted to secure the ladder to a wall of a building, and also showing apertures having substantially rectangular shapes.

FIG. 4 is a front elevation of the belting ladder having an alternative arrangement of the apertures.

FIG. 5 is a side view of the belting ladder in coiled orientation mounted on a roof of a building.

FIG. 6 is a side view of the belting ladder in coiled orientation secured to a storage arrangement anchored to a building.

FIG. 7 is a side view of the belting ladder forming a coil carried by a person as a backpack.

FIG. 8 is an isometric view of an endless belting ladder.

FIG. 9 is a perspective view of the belting ladder used on a helicopter.

FIG. 10 is another perspective view of the belting ladder used on a helicopter.

### DETAILED DESCRIPTION OF PREFERRED EMBODIMENTS

FIGS. 1-10 illustrate an inventive belting ladder 10 which is a preferred embodiment of the invention. Referring to the figures, belting ladder 10 includes an elongated band 20 with a width 21 of a flat flexible reinforced belting material 22 having a plurality of longitudinally-spaced apertures 30 each with a substantially transverse edge 32 portion thereby forming rung-like features along belting material 22 to receive a person's foot or hand, and an attachment device 40 at an end 24 of band 20.

Width 21 of band 20, depending on where the belting ladder is intended to be used, may be approximately ten inches, as shown on FIGS. 1-3. Alternatively, if conditions require a bigger ladder to accommodate a larger number of people using the ladder simultaneously, width 21 of belting ladder 10 can be twenty inches or wider and have therefore more longitudinally-spaced apertures 30. An example of such alternative ladder 10 is shown on FIG. 4.

As seen on FIGS. 1, 2 and 4 apertures 30 may have substantially round shapes with diameter 35 of approximately six inches.

FIG. 3 shows one of the preferred embodiments having transverse edge portions 32 being substantially straight horizontal with belting ladder 10 being vertically oriented. Apertures 30 on FIG. 3 have substantially rectangular shapes 36 which are approximately six inches wide and approximately six inches high.

FIG. 3 further illustrates certain highly preferred embodiment having attachment device 40 adapted to secure ladder 10 with respect to a wall 3 of a building 2. Such attachment device 40 further comprises a bracket 41 pivotably connected to a hinge 42 fastened to end 24 of belting ladder 10.

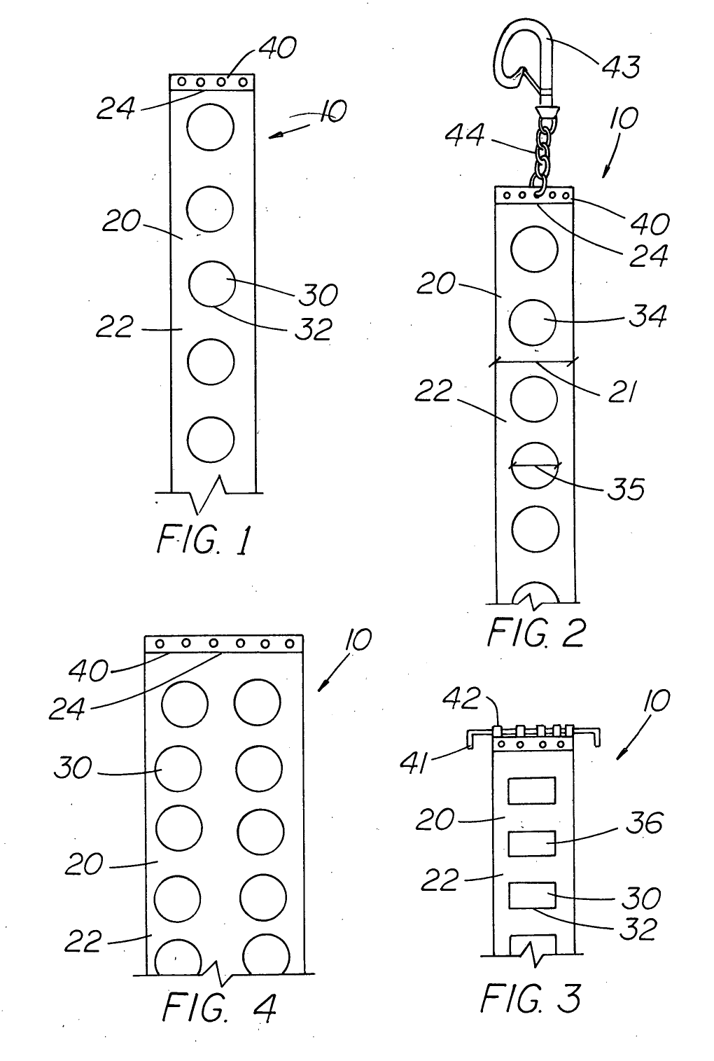

FIG. 2 and 7 illustrate another highly preferred embodiment of belting ladder 10 designed for coiling into a roll 12 dimensioned for carrying by a person 1 as a backpack. As best seen on FIG. 2, attachment device 40 is an arrangement comprising a hook 43 linked with a chain 44 coupled to end 24 of belting ladder 10.

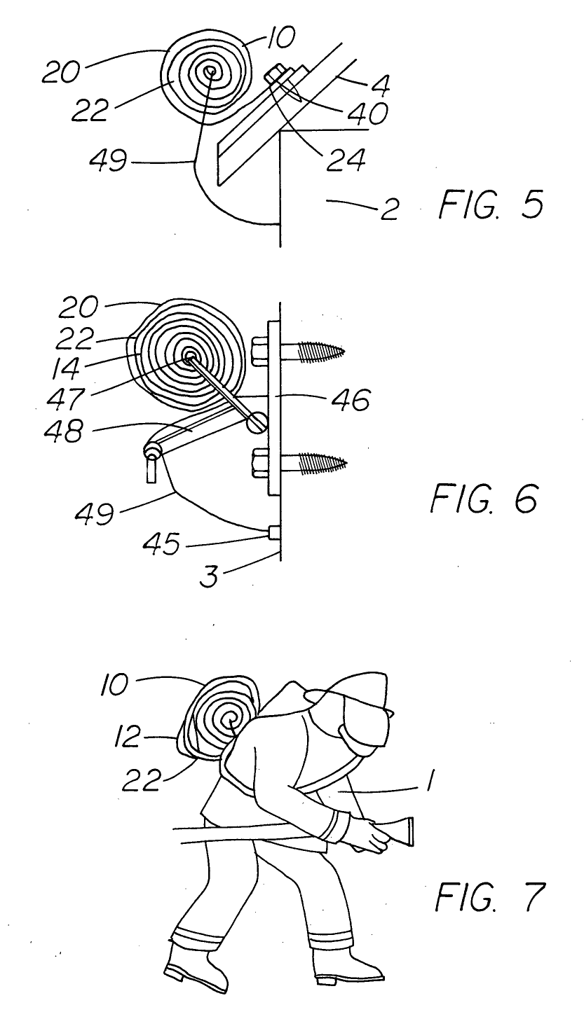

FIG. 5 shows yet another preferred embodiment of this invention featuring belting ladder 10 with attachment device 40 adapted for mounting belting ladder 10 on a roof 4 of building 2.

FIG. 6 illustrates belting ladder 10 secured by attachment device 40 to a storage arrangement 46 anchored to building 2 for a long term storing of belting ladder 10 for an immediate availability of ladder 10 should an emergency arise.

As seen on FIG. 6, storage arrangement 46 includes at least one substantially cylindrical member 47 rotatably secured with respect to a support structure 48 anchored to building 2. Belting ladder 10 is secured to cylindrical member 47 by its end 24 of band 20. Belting ladder 10 forms a coil 14 for storing, and attachment device 40 further includes a tug-tab 49 for releasing belting ladder 10 from a coiled orientation into an extended suspended orientation. In some cases, the fire-escape belting ladder may further include an alarm-actuated device 45 for releasing belting ladder 10.

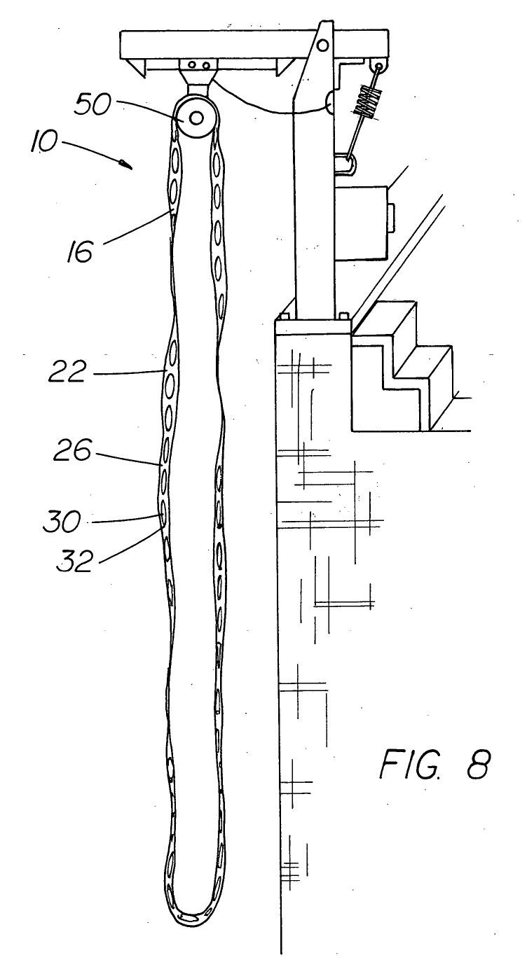

Another aspect of this invention is illustrated on FIG. 8 showing an endless belting ladder 16 comprising an endless elongated band 26 of belting material 22. Endless belting ladder 16 may form an escape system for building 2 by securing endless band 26 on a pulley system 50 for the continuing descending movement of belting ladder 16.

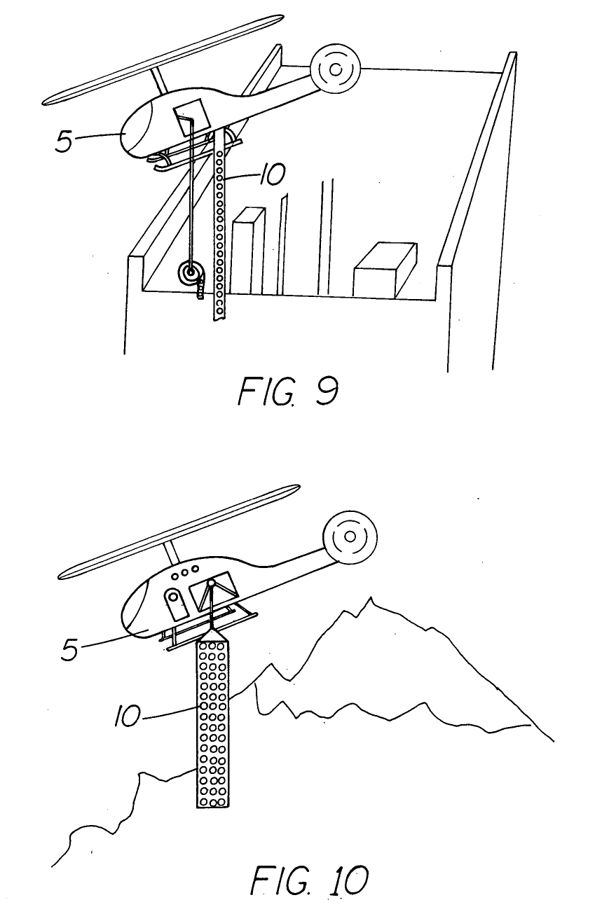

FIG. 9 shows a possible use of ladder 10 accommodating access to a location not permitting landing of a helicopter 5.

FIG. 10 shows another situation where ladder 10 used for helicopter 5 drop off or retrieval of mountain rescue.

While the principles of the invention have been shown and described in connection with specific embodiments, it is to be understood that such embodiments are by way of example and are not limiting.

1. A belting ladder comprising:
an elongated band of a flat flexible reinforced belting material having a plurality of longitudinally-spaced apertures each with a substantially transverse edge portion thereby forming rung-like features along the belting material to receive a person's foot or hand; and
an attachment device at an end of the band.

2. The belting ladder of claim 1 wherein the belting material is conveyer belting.

3. The belting ladder of claim 1 wherein the apertures have substantially round shapes.

4. The belting ladder of claim 1 wherein the transverse edge portions are substantially straight horizontal edges when the belting ladder is vertically oriented.

5. The belting ladder of claim 4 wherein the apertures have substantially rectangular shapes.

6. The belting ladder of claim 1 wherein the attachment device is adapted to secure the ladder with respect to a building wall.

7. The belting ladder of claim 6 wherein the attachment device comprises a bracket pivotably connected to a hinge fastened to the end of the belting ladder.

8. The belting ladder of claim 1 wherein the belting ladder is designed for coiling into a roll dimensioned for carrying by a person as a backpack.

9. The belting ladder of claim 8 wherein the attachment device is an arrangement comprising a hook linked with a chain coupled to the end of the belting ladder.

10. The belting ladder of claim 1 wherein the attachment device is a mechanism for mounting the belting ladder on a roof of a building.

11. A fire-escape belting ladder for a building comprising:
an elongated band of a flat flexible reinforced belting material having a plurality of longitudinally-spaced apertures each with a substantially transverse edge portion thereby forming rung-like features along the belting material to receive a person's foot or hand; and
an attachment device securing the belting ladder to a storage arrangement for anchoring to the building.

12. The fire-escape belting ladder of claim 10 wherein the belting material is conveyer belting.

13. The fire-escape belting ladder of claim 11 wherein the apertures have substantially round shapes.

14. The fire-escape belting ladder of claim 11 wherein the transverse edge portions are substantially straight horizontal edges when the belting ladder is vertically oriented.

15. The fire-escape belting ladder of claim 14 wherein the apertures have substantially rectangular shapes.

16. The fire-escape belting ladder of claim 11 wherein the belting ladder forms a coil for storing.

17. The fire-escape belting ladder of claim 16 wherein the attachment device includes a tug-tab for releasing the belting ladder from a coiled orientation into an extended suspended orientation.

18. The fire-escape belting ladder of claim 16 further including an alarm-actuated device for releasing the belting ladder.

19. The fire-escape belting ladder of claim 11 wherein:
the storage arrangement includes at least one substantially cylindrical member rotatably secured with respect to a support structure for anchoring to a building; and
the band has an upper end secured to the cylindrical member.

20. An endless belting ladder comprising an endless elongated band of a flat flexible reinforced belting material having a plurality of longitudinally-spaced apertures each with a substantially transverse edge portion thereby forming rung-like features along the belting material to receive a person's foot or hand.

21. The endless belting ladder of claim 20 wherein the belting material is conveyer belting.

22. The endless belting ladder of claim 20 wherein the apertures have substantially round shapes.

23. The endless belting ladder of claim 20 wherein the transverse edge portions are substantially straight horizontal edges when the belting ladder is vertically oriented.

24. The endless belting ladder of claim 23 wherein the apertures have substantially rectangular shapes.
